(19) United States
(12) Patent Application Publication
(10) Pub. No.: US 2011/0190985 A1
(43) Pub. Date: Aug. 4, 2011

(54) METHOD AND SYSTEM FOR ESTIMATING A CORNERING LIMIT OF AN AUTOMOTIVE VEHICLE AND A COMPUTER PROGRAM PRODUCT FOR CARRYING OUT SAID METHOD

(75) Inventors: Jonas BILLBERG, Eskilchon (SE); Andreas DOUHAN, Koeping (SE); Matthijs KLOMP, Ljungskile (SE)

(73) Assignee: GM GLOBAL TECHNOLOGY OPERATIONS LLC, Detroit, MI (US)

(21) Appl. No.: 13/017,377

(22) Filed: Jan. 31, 2011

(30) Foreign Application Priority Data
Feb. 1, 2010 (GB) 1001582.4

(51) Int. Cl. B62D 6/00; G06F 19/00

(52) U.S. Cl. 701/41; 701/1

(57) ABSTRACT

A method and a system are provided for estimating a cornering limit of an automotive vehicle and a computer program product with a computer method code for carrying out the method. The method includes, but is not limited to sensing vehicle operating conditions and a vehicular yaw rate \dot{Ψ}; detecting a lateral acceleration a_{y} of the vehicle calculating vehicle parameters a yaw rate reference value \dot{Ψ}_{ref}, and a yaw rate error \dot{Ψ}ₑᵣᵣₒᵣ on the basis of the yaw rate reference value \dot{Ψ}_{ref} and the vehicular yaw rate \dot{Ψ}. If the lateral acceleration a_{y} is determined as being unequal to zero, it is estimated whether the vehicle operating conditions, the vehicle parameters and the yaw rate error \dot{Ψ}ₑᵣᵣₒᵣ are within a predetermined range of given thresholds. If the vehicle operating conditions, the vehicle parameters and the yaw rate error \dot{Ψ}ₑᵣᵣₒᵣ are within a predetermined range of the given thresholds, a warning step (f) of triggering a driver warning and/or a control step (g) of controlling the vehicle operating conditions are performed.

### CROSS-REFERENCE TO RELATED APPLICATION

This application claims priority to British Patent Application No. 1001582.4, filed Feb. 1, 2010, which is incorporated herein by reference in its entirety.

### TECHNICAL FIELD

The technical field relates to a method for estimating a cornering limit of an automotive vehicle to enable a stable cornering of the vehicle and, in particular, to an identification strategy that detects critical situations when cornering near the vehicle limits which can be used to trigger a driver warning.

### BACKGROUND

When an automotive vehicle enters a corner, tires of the vehicle turn with respect to the ground and a sideways force is produced by the tires. The force is generated by a steering wheel angular displacement of a vehicular steering wheel and is further influenced by a non-neutral steering of the vehicle due to weight distribution, suspension design, kind and state of the used tires, lateral acceleration and by road condition. There is further a lengthwise pulling force from the engine resulting from a vehicular velocity.

The vehicle now follows the direction of turn, given by the angular displacement of the vehicular steering wheel, until the resulting force from a combination of the sideways and the lengthwise force is in excess of or, less than, a possible static friction of a tire of the vehicle. If the resulting force is in excess of the static friction, the tire will loose its grip. The vehicle then pushes in the direction of an output vector set before a steering angular displacement of the steering wheel was carried out. This results in the driver feeling that there is less radius of curvature than needed. This situation is referred to as understeering.

Further, when the resulting force is less than the static friction of the vehicle, the vehicle has the tendency of cornering more than given by a steering wheel angular displacement. This is referred to as oversteering. Oversteering may, for example be caused by a rear axle of the vehicle breaking away further than a front axle due to the acting forces. This could lead the vehicle to incline towards an inside of the corner. Therefore, it becomes necessary to match vehicle power and the cornering limit at a particular vehicle speed to provide a stable cornering.

Electronic control units may be used to estimate a cornering limit in response to the vehicle dynamic parameters. A first example is disclosed in U.S. Pat. No. 6,615,124 B1. The estimation system described therein controls a brake force for each tire and a rear tire steering angular displacement so as to restrain a deviation between an estimated value and a target value of a yaw rate gain. These values are compared by use of a linear estimation system, whereby a road surface condition is denoted by a road surface frictional coefficient, which has to be further estimated.

A method of estimating the road surface frictional coefficient is disclosed in U.S. Pat. No. 6,015,192, where the road surface frictional coefficient is gained graphically and arithmetically estimated using a regression line, illustrating the relation between longitudinal force of a vehicle and wheel speed of the vehicle. The regression line is regarded as linear and a non linearity compensation coefficient is used to compensate for a deviation from the ideal linearity.

A second example is disclosed in U.S. Pat. No. 7,252,346 B2. This estimation system estimates whether a cornering state variable of a vehicle is within a predetermined range of a braking operation threshold value of a vehicle and, if necessary, starts a brake control apparatus to enlarge a pressure of a brake liquid after a predetermined delay time is elapsed from a present time and to automatically decelerate the vehicle.

A third example is disclosed in US 2006/0259222 A1. The estimation system described generates an assist torque signal for the steering system in response to a driver's applied torque and a haptic torque, which is arranged to be added to the torque assist signal, to decrease a driver's steering effort corresponding to an increasing cornering instability of a vehicle.

However, there are several disadvantages associated with these examples. The first example requires the input of a road surface frictional coefficient. Therefore, difficult available friction estimates have to be solved which leads to increased memory requirements of a modem power assist steering system and to the use of a higher amount of power than desired. Further, in the example of estimation of the frictional coefficient in U.S. Pat. No. 6,015,192, an ideal liner proportionality is used, which becomes less accurate as the vehicle becomes non-linear, for example during increasing understeer.

The second example includes an electro-hydraulic system in which the power assist is provided by hydraulic means and is not applicable to different kinds of control systems or driver warnings. Further, because of the delay time, the estimating section cannot address to difficult driving situations, for example frequently sequenced angular displacements of a vehicular steering wheel, which may lead to a steering manoeuvre different from that which the driver desires, because of a slight shift arising between the result of estimation and the actual current value.

In the third example, the number of sensors is increased because of estimating a driver torque. A further motor is also used to generate an assist torque signal, which leads to a higher amount of power and further results in increased manufacturing costs. Furthermore, calculating or estimating a torque is a function of a longitudinal force, the radius of curvature and/or the direction of turn. Directly sensing or estimating a longitudinal force is however difficult and may be inaccurate. Due to the estimated torque being a function of the radius of curvature and the direction of turn, this system is not robust to changes in driving conditions, such as a changing radius of curvature or a changed direction of turn, since it requires a long time for new measurement of the vehicle parameters and conditions. This leads to a delay time until the assist torque signal or the haptic torque are generated. In a cornering operation of a vehicle, differences in the velocity arise among the wheels and, therefore, a different torque has to be applied to the left wheels compared to the right wheels. Therefore, the given steering manoeuvre may be different from that which the driver desires.

It is therefore at least one object to provide a method and system for estimating a cornering limit of an automotive vehicle, which may use information already embodied in the vehicle, which is robust to variations in the road surface and changes in the driving conditions. In addition, other objects, desirable features and characteristics will become apparent from the subsequent summary and detailed description, and the appended claims, taken in conjunction with the accompanying drawings and this background.

### SUMMARY

A method is provided for estimating a cornering limit of an automotive vehicle comprising: a sensing step of sensing vehicle operating conditions and a vehicular yaw rate; a detecting step of detecting a lateral acceleration of the vehicle and determining whether the lateral acceleration is equal to zero; a calculating step of calculating vehicle parameters and a yaw rate reference value; a calculating step of calculating a yaw rate error on the basis of the yaw rate reference value and the previously sensed vehicular yaw rate; if the lateral acceleration is determined as being unequal to zero, an estimating step of estimating whether the vehicle operating conditions, the vehicle parameters and the yaw rate error are within a predetermined range of given thresholds, responsive to a driving situation of the vehicle and/or a road surface condition, is performed; a warning step of triggering a driver warning is performed. If the vehicle operating conditions, the vehicle parameters and the yaw rate error are within a predetermined range of the given thresholds, in an embodiment a warning step of triggering a driver warning is performed. In a further embodiment, a control step is performed. In a further embodiment, a warning step and a control step are performed.

This method may be used trigger any desired driver warning such as to trigger a light or sound. It is applicable for a temporal braking operation or a temporal releasing operation. The method is further robust to variations in the road surface, such as asphalt or snow and also robust to changes in the driving situations, without estimating a road surface frictional coefficient.

The step of detecting a lateral acceleration, the steps of calculating vehicle parameters, a yaw rate reference value and a yaw rate error can be performed in any order and the method is not limited to performing them in the order given in the embodiments.

According to an embodiment, the step of sensing vehicle operating conditions comprises the steps of sensing a vehicular velocity, a steering wheel angular displacement of a vehicular steering wheel, a vehicular yaw rate and a lateral acceleration of the vehicle. Values of these parameters may be obtained from signals from standard dynamic measurements and from the sensors already provided on the vehicle and used for other purposes such as power steering control. Any sensor suitable for these purposes may be employed.

In an embodiment, the calculating step comprises calculating a yaw rate reference value, a vehicular yaw acceleration and a steering wheel angular velocity. These vehicle parameters may be calculated by use of a commercially available software package simulating the dynamical behaviour of a vehicle to calculate the parameters readily and reliably while the vehicle is in motion. In a further embodiment, a linear bicycle model may be used to obtain the yaw rate reference value.

In an embodiment a yaw rate error is calculated according to the following equation by subtracting the yaw rate reference value \dot{Ψ}_{ref} from the measured yaw rate \dot{Ψ}:

\dot{Ψ}ₑᵣᵣₒᵣ=\dot{Ψ}−\dot{Ψ}_{ref} (1)

This step of calculating a yaw rate error further indicates if there is a difference between the measured yaw rate and the calculated yaw rate reference value and whether the vehicle is operating in a linear range. It should be noted, that the error due to nonlinearity is much higher than the error due to a deviation between the vehicle parameters. Further, the yaw rate error can be also calculated by using a full car model for a four wheeled vehicle, instead of the described linear bicycle model.

According to another embodiment, a system of inequalities is used to estimate whether the vehicle operating conditions, the vehicle parameters and the yaw rate error are within a predetermined range of given thresholds, responsive to the determined driving situation of the vehicle and/or to a road surface condition.

In an embodiment, the driving situation can be overtaking an obstacle, ramp steering or a curving manoeuvre and the road surface condition can be asphalt or snow. Therefore, the method is robust to variations in the road surface, such as asphalt or snow and, therefore, to different road friction surfaces, such as a low friction surface or a high friction surface, without estimating a road surface frictional coefficient. The method is further robust to changes in the driving situations, because consequently, the method is applicable when the driving situation is overtaking an obstacle, ramp steering, or when the driving situation is a weaving manoeuvre, for example sine with dwell.

The system of inequalities comprises one or more conditions, wherein each condition of the system of inequalities includes set criteria for the yaw rate error, the yaw acceleration, the steering wheel angular displacement, the steering wheel angular velocity and/or the lateral acceleration. The thresholds for the absolute value of the yaw rate error and on the steering wheel angular displacement serve to differentiate the manoeuvre and, further, to prevent false warnings. Each condition of the system of inequalities specifies one driving situation and one road surface condition. Therefore, the method is applicable for one or more driving situations and one or more road surface conditions.

In dynamic manoeuvres, such as overtaking an obstacle or a curving manoeuvre, the absolute value of the yaw rate error helps to separate the type of dynamic manoeuvre since the absolute value of the yaw rate error increases significantly during high lateral accelerations, which occur during dynamic cornering manoeuvres. The thresholds on the yaw acceleration and the steering wheel angular velocity enable an estimate of the dynamic level of the cornering manoeuvre. Therefore, the system of inequalities includes set criteria for all measured and calculated vehicle dynamics. By setting criteria for each of the dynamic parameters that are measured or calculated, it becomes possible to activate a driver warning in good time before the cornering limit has been reached.

According to an embodiment, the estimating step determines, whether all set criteria of a condition of the system of inequalities are fulfilled or not. When all set criteria of a condition of the system of inequalities are fulfilled, it is an indication that the cornering limit will be reached and, therefore, it becomes possible to warn the driver in good time before the cornering limit has been reached.

If the system of inequalities comprises one condition, the estimating step determines, if all set criteria of the condition are fulfilled or not and the method continues with the warning step and/or the control step if all set criteria are fulfilled, or returns to the beginning if all set criteria are not fulfilled. If the system of inequalities comprises two or more conditions, the estimating step detects if all set criteria of an condition of the two or more conditions of the system of inequalities are fulfilled for one condition of the two or more conditions after another, beginning with a first condition of the two or more conditions and the method continues with the warning step and/or the control step if all set criteria of the first condition are fulfilled, or determines the set criteria of a next condition of the system of inequalities if the set criteria of the first condition are not fulfilled and returns to the beginning, if all set criteria of none of the two or more conditions of the system of inequalities are fulfilled.

By setting the estimation system and, therefore, the driver warning, preferably a warning threshold, as a function of the driving situation and/or the road surface condition, it is possible to significantly reduce the rate of false warnings, without a loss of safety, because a warning is only triggered if there is an indication that the cornering limit will be reached. The acceptance of the method is thereby advantageously improved.

In an embodiment, the system of inequalities, used in this method comprises one or more of the group of inequalities consisting of:

|\dot{Ψ}ₑᵣᵣₒᵣ/a_{y}|>th_{DLC} [symbol] |δ_{SW}|>δhd DLC [symbol] |\dot{δ}_{SW}′>\dot{δ}_{DLC} [symbol] |\dot{Ψ}ₑᵣᵣₒᵣ|>\dot{Ψ}ₑᵣᵣₒᵣ_{_{—}}_{DLC} [symbol] |\ddot{Ψ}|<\ddot{Ψ}_{DLC} (2)

|\dot{Ψ}ₑᵣᵣₒᵣ/a_{y}|>th_{DLC} [symbol] |δ_{SW}|>δ_{DLC}_{_{—}}ₛ [symbol] (\dot{δ}_{DLC}_{_{—}}ₛ₁<|\dot{δ}_{SW}|<\dot{δ}_{DLC}_{_{—}}ₛ₂) [symbol] |\dot{Ψ}ₑᵣᵣₒᵣ|>\dot{Ψ}ₑᵣᵣₒᵣ_{_{—}}_{DLC}_{_{—}}ₛ [symbol] (\ddot{Ψ}_{DLC}_{_{—}}ₛ₁<|\ddot{Ψ}|<\ddot{Ψ}_{DLC}_{_{—}}ₛ₂) (3)

|\dot{Ψ}ₑᵣᵣₒᵣ/a_{y}|>thᵣₐₘₚ₁ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP} (4)

|\dot{Ψ}ₑᵣᵣₒᵣ/a_{y}²|>thᵣₐₘₚ₂ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP} (5)

|\dot{Ψ}ₑᵣᵣₒᵣ/\dot{Ψ}_{ref}|>th_{SDW} [symbol] a_{y}|>a_{y}_{_{—}}_{SWD} [symbol] |δ_{SW}|>δ_{SWD} [symbol] |\dot{δ}_{SW}|>\dot{δ}_{SWD} [symbol] |\dot{Ψ}ₑᵣᵣₒᵣ|>\dot{Ψ}ₑᵣᵣₒᵣ_{_{—}}_{SWD} [symbol] |\ddot{Ψ}|>\ddot{Ψ}_{SWD} (6)

|\dot{Ψ}ₑᵣᵣₒᵣ/a_{y}²|>th_{SDW-s} [symbol] |δ_{SW}|>δ_{SWD} [symbol] (\dot{δ}_{SWD}_{_{—}}ₛ₁<|\dot{δ}_{SW}|<\dot{δ}_{SWD}_{_{—}}ₛ₂) [symbol] (\dot{Ψ}ₑᵣᵣₒᵣ_{_{—}}_{SWD}_{_{—}}ₛ₁<|\dot{Ψ}ₑᵣᵣₒᵣ|<\dot{Ψ}ₑᵣᵣₒᵣ_{_{—}}_{SWD}_{_{—}}ₛ₂) [symbol] |\ddot{Ψ}|<\ddot{Ψ}_{SWD}_{_{—}}ₛ (7)

Therein, \dot{Ψ}ₑᵣᵣₒᵣ denotes the yaw rate error, \dot{Ψ}_{ref} denotes the yaw rate reference value, a_{y} denotes the lateral acceleration, δ_{SW} denotes the steering wheel angular displacement, \dot{δ}_{SW} denotes the steering wheel angular velocity, \ddot{Ψ} denotes the vehicular yaw acceleration.

Condition (1) specifies the situation when the driving situation is overtaking an obstacle and the road surface condition is asphalt. Thereby, th_{DLC} denotes a threshold value for the absolute value of the yaw rate error, which is normalized with the lateral acceleration, δ_{DLC} denotes a steering wheel angular displacement lower limit, \dot{δ}_{DLC} denotes a steering wheel angular velocity lower limit, \dot{Ψ}ₑᵣᵣₒᵣ_{_{—}}_{DLC} denotes a yaw rate error lower limit and \ddot{Ψ}_{DLC} denotes a yaw acceleration upper limit.

Condition (2) specifies the situation when the driving situation is overtaking an obstacle and the road surface condition is snow. Thereby, δ_{DLC}_{_{—}}ₛ denotes a steering wheel angular displacement lower limit, \dot{δ}_{DLC}_{_{—}}ₛ₁ denotes a steering wheel angular velocity lower limit, \dot{δ}_{DLC}_{_{—}}ₛ₂ denotes a steering wheel angular velocity upper limit, \dot{Ψ}ₑᵣᵣₒᵣ_{_{—}}_{DLC}_{_{—}}ₛ denotes a yaw rate error lower limit, \ddot{Ψ}_{DLC}_{_{—}}ₛ₁ denotes a yaw acceleration lower limit and \ddot{Ψ}_{DLC}_{_{—}}ₛ₂ denotes a yaw acceleration upper limit.

Condition (3) specifies the situation when the driving situation is ramp steering and the road surface condition is asphalt. Thereby, thᵣₐₘₚ₁ denotes a threshold value for the absolute value of the yaw rate error, which is again normalized with the lateral acceleration, δ_{RAMP1} denotes a steering wheel angular displacement lower limit, δ_{RAMP2} denotes a steering wheel angular displacement upper limit, \dot{δ}_{RAMP} denotes a steering wheel angular velocity upper limit, \dot{Ψ}ₑᵣᵣₒᵣ_{_{—}}_{RAMP} denotes a yaw rate error lower limit and \ddot{Ψ}_{RAMP} denotes a yaw acceleration upper limit.

Condition (4) specifies the situation when the driving situation is ramp steering and the road surface condition is snow. Thereby, thᵣₐₘₚ₂ denotes a threshold value for the absolute value of the yaw rate error, which is normalized with the lateral acceleration raised to the second power. Herein, the yaw rate error is normalized with the lateral acceleration raised to the second power to avoid false warnings that may otherwise occur.

Condition (5) specifies the situation when the driving situation is a curving manoeuvre and the road surface condition is asphalt. Thereby, th_{sdw} denotes a threshold value for the absolute value of the yaw rate error, which is normalized with the yaw rate reference value, a_{y}_{_{—}}_{SWD} denotes a lateral acceleration lower limit, δ_{SWD} denotes a steering wheel angular displacement lower limit, \dot{δ}_{SWD} denotes a steering wheel angular velocity lower limit, \dot{Ψ}ₑᵣᵣₒᵣ_{_{—}}_{SWD} denotes a yaw rate error lower limit and \dot{Ψ}_{SWD} denotes a yaw acceleration upper limit. Herein, the yaw rate error is normalized with the calculated yaw rate reference value instead of the lateral acceleration. The reason for this is to avoid false warnings that may otherwise occur due to the problematic associated with different friction surfaces.

Condition (6) specifies the situation when the driving situation is a curving manoeuvre and the road surface condition is snow. Thereby, th_{SDW}_{_{—}}ₛ denotes a threshold value for the absolute value of the yaw rate error, which is normalized with the lateral acceleration raised to the second power, \dot{δ}_{SWD}_{_{—}}ₛ₁ denotes a steering wheel angular velocity lower limit, \dot{δ}_{SWD}_{_{—}}ₛ₂ denotes a steering wheel angular velocity upper limit, \dot{Ψ}ₑᵣᵣₒᵣ_{_{—}}_{SWD}_{_{—}}ₛ₁ denotes a yaw rate error lower limit, \dot{Ψ}ₑᵣᵣₒᵣ_{_{—}}_{SWD}_{_{—}}ₛ₁ denotes a yaw rate error upper limit and \dot{Ψ}_{SWD}_{_{—}}ₛ denotes a yaw acceleration lower limit.

According to another embodiment, a warning system is triggered when all set criteria responsive to a condition of the system of inequalities are true, or a control step controls the vehicle operating conditions when all set criteria of one condition of all the set criteria of one condition of the system of inequalities are fulfilled. Therefore, a warning system is triggered when all criteria, exemplified by the inequalities, of a condition are true, which is an indication that the cornering limit will be reached, and a warning signal is sent to the driver. This warning signal is sent so as to warn the driver that the cornering limit will be reached if no correcting action is taken. The warning signal is sent some time prior to the vehicle reaching its cornering limit so as to give the driver sufficient time to take correcting action.

According to another embodiment, the above described object is also be achieved by providing a system for estimating a cornering limit of an automotive vehicle, the system comprising: a sensor group for sensing vehicle operating conditions of the vehicle, wherein the sensor group comprises a vehicular velocity sensor to detect a vehicular velocity, a steering wheel angular displacement sensor to detect a steering angular displacement of a vehicular steering wheel, a yaw rate sensing means to detect a vehicular yaw rate and a lateral acceleration sensor to detect a lateral acceleration of the vehicle; an electronic control unit, the electronic control unit comprising: a vehicle condition detector responsive to the lateral acceleration sensor signal to determine whether the lateral acceleration is equal to zero or not, a vehicular parameter calculating section responsive to the signals of the sensor group to calculate vehicle parameters, such as a yaw rate reference value, a yaw acceleration and a steering wheel angular velocity of the vehicular steering wheel, a yaw rate error calculating means responsive to the signal of the yaw rate sensing means and the yaw rate reference value to calculate a yaw rate error, an estimating unit to estimate if the vehicle operating conditions and the vehicle parameters are within a predetermined range of the given thresholds, and an alarm unit responsive to the signals of the estimating unit to trigger a driver warning if the vehicle operating conditions and the vehicle parameters are within a predetermined range of the given thresholds; and a driver warning responsive to the signal of the alarm unit to warn a driver. In an embodiment the given thresholds are values of a driving situation and/or a road surface condition.

The embodiments also provide a computer program product comprising a computer method code for carrying out said method.

### BRIEF DESCRIPTION OF THE DRAWINGS

The present invention will hereinafter be described in conjunction with the following drawing figures, wherein like numerals denote like elements, and

FIG. 1 is flow chart diagram illustrating a method for estimating a cornering limit according to an embodiment;

FIG. 2 is a flow chart illustrating a detailed part of the method of FIG. 1 according to an embodiment;

FIG. 3 is a flow chart illustrating detailed steps of the method of FIG. 1 according to an embodiment;

FIG. 4 is a block diagram illustrating an estimation system, according to an embodiment; and

FIG. 5 is a schematic functional block diagram characteristics graph of an electronic control unit, according to the embodiment of FIG. 3.

### DETAILED DESCRIPTION

The following detailed description is merely exemplary in nature and is not intended to limit application and uses. Furthermore, there is no intention to be bound by any theory presented in the preceding background or summary or the following detailed description.

There are shown a sensing step (a) of sensing vehicle operating conditions and a vehicular yaw rate \dot{Ψ}; a detecting step (b) of detecting a lateral acceleration a_{y} of the vehicle and determining whether the lateral acceleration a_{y} is equal to zero; a calculating step (c) of calculating vehicle parameters and a yaw rate reference value \dot{Ψ}_{ref}; a calculating step (d) of calculating a yaw rate error \dot{Ψ}ₑᵣᵣₒᵣ on the basis of the yaw rate reference value \dot{Ψ}_{ref} and the previously sensed vehicular yaw rate \dot{Ψ}; if the lateral acceleration a_{y} is determined as being unequal to zero, performing an estimating step (e) of estimating whether the vehicle operating conditions, the vehicle parameters and the yaw rate error \dot{Ψ}ₑᵣᵣₒᵣ are within a predetermined range of given thresholds, responsive to a driving situation and a road surface condition; a warning step (f) of triggering a driver warning if the vehicle operating conditions, the vehicle parameters and the yaw rate error \dot{Ψ}ₑᵣᵣₒᵣ are within a predetermined range of the given thresholds; and/or a control step (g) of controlling the vehicle operating conditions so that the vehicle operating conditions, the vehicle parameters and the yaw rate error are within a predetermined range of given thresholds.

The step of detecting a lateral acceleration a_{y}, the steps of calculating vehicle parameters, a yaw rate reference value \dot{Ψ}_{ref} and a yaw rate error \dot{Ψ}ₑᵣᵣₒᵣ can be performed in any order and the method is not limited to performing them in the order given in the embodiments.

First of all, at a step a, vehicle operating conditions are read, based on the signals from standard dynamic sensor measurements. After the input of the vehicle state information at step a, at a step b, it is detected, whether the lateral acceleration of the vehicle a_{y} is equal to zero or not. If the lateral acceleration a_{y} is unequal to zero, it is an indication that the vehicle enters a corner and the estimating method continues at a step c. Otherwise, if the lateral acceleration a_{y} is detected as being equal to zero, this indicates that the vehicle is driving straight on, so that steps c to g are not performed and the method returns to step a.

At a step c, the vehicle state information is used to calculate vehicle parameters. The vehicle parameters can be calculated by use of common software packages simulating the dynamical behaviour of a vehicle.

At a step d, the resulting calculated yaw rate reference value \dot{Ψ}_{ref} is compared with the measured vehicular yaw rate \dot{Ψ} to obtain a yaw rate error \dot{Ψ}ₑᵣᵣₒᵣ according to the following equation:

\dot{Ψ}ₑᵣᵣₒᵣ=\dot{Ψ}\dot{−}\dot{Ψ}_{ref}.

After that, at a step e, it is determined if the cornering limit will be reached at a predetermined point in time in the future, responsive to a driving situation and/or a road surface condition, using a system of inequalities.

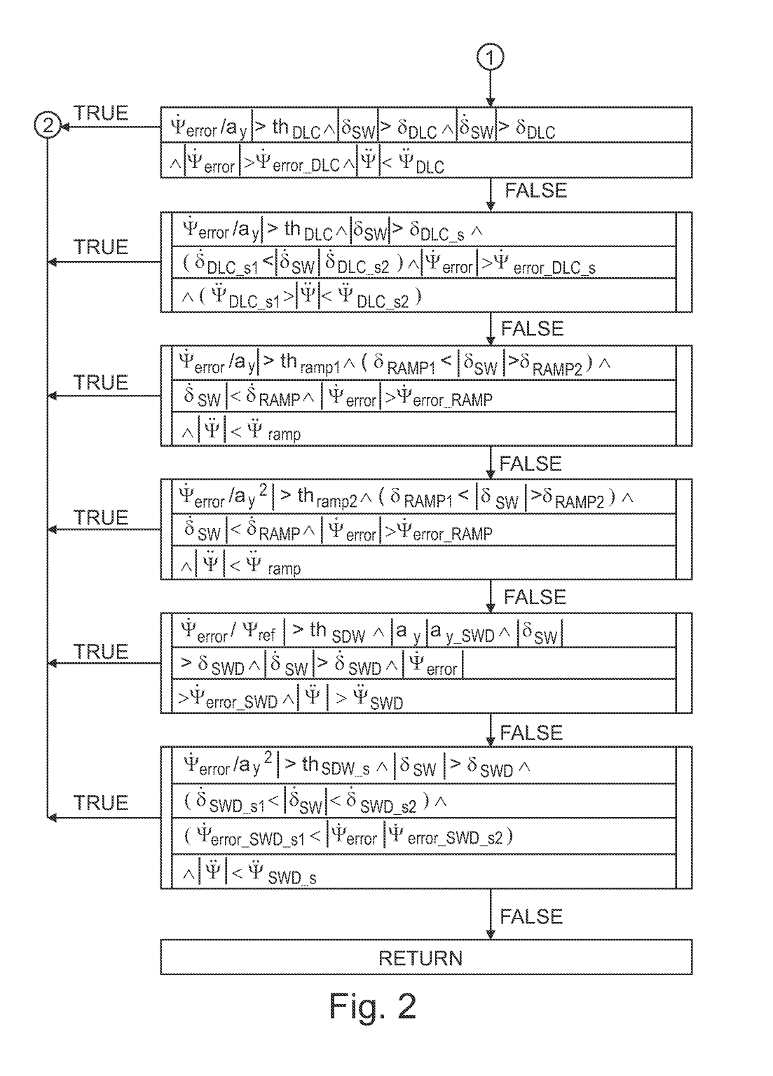

FIG. 2 illustrates in detail the step (e) of the method according to an embodiment of the present invention in the form of a flow diagram. In this embodiment, the system of inequalities comprises six different conditions, each having set criteria. In further embodiments, the system of inequalities comprises fewer then six and more than six different conditions.

The method includes determining whether the set criteria of one of the conditions of the system of inequalities are fulfilled, beginning with a first condition of the conditions of the system of inequalities and the method continues at the warning step (f) and/or the control step (g) if the set criteria of the first condition are fulfilled, or determines the set criteria of a next condition if the set criteria of the first condition are not fulfilled, and/or the method returns to step (a) if all set criteria of none of the conditions of the system of inequalities are fulfilled.

In the following, the estimating step (e) will be exemplified according to the embodiment shown in FIG. 2. In this embodiment the yaw rate error \dot{Ψ}ₑᵣᵣₒᵣ, the yaw acceleration \ddot{Ψ}, the steering wheel angular displacement δ_{SW}, and the steering wheel angular velocity \dot{δ}_{SW} are compared with given thresholds as:

|\dot{Ψ}ₑᵣᵣₒᵣ/a_{y}|>th_{DLC} [symbol] |δ_{SW}|>δhd DLC [symbol] |\dot{δ}_{SW}′>\dot{δ}_{DLC} [symbol] |\dot{Ψ}ₑᵣᵣₒᵣ|>\dot{Ψ}ₑᵣᵣₒᵣ_{_{—}}_{DLC} [symbol] |\ddot{Ψ}|<\ddot{Ψ}_{DLC} (2)

|\dot{Ψ}ₑᵣᵣₒᵣ/a_{y}|>th_{DLC} [symbol] |δ_{SW}|>δ_{DLC}_{_{—}}ₛ [symbol] (\dot{δ}_{DLC}_{_{—}}ₛ₁<|\dot{δ}_{SW}|<\dot{δ}_{DLC}_{_{—}}ₛ₂) [symbol] |\dot{Ψ}ₑᵣᵣₒᵣ|>\dot{Ψ}ₑᵣᵣₒᵣ_{_{—}}_{DLC}_{_{—}}ₛ [symbol] (\ddot{Ψ}_{DLC}_{_{—}}ₛ₁<|\ddot{Ψ}|<\ddot{Ψ}_{DLC}_{_{—}}ₛ₂) (3)

|\dot{Ψ}ₑᵣᵣₒᵣ/a_{y}|>thᵣₐₘₚ₁ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP} (4)

|\dot{Ψ}ₑᵣᵣₒᵣ/a_{y}²|>thᵣₐₘₚ₂ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP} (5)

|\dot{Ψ}ₑᵣᵣₒᵣ/\dot{Ψ}_{ref}|>th_{SDW} [symbol] a_{y}|>a_{y}_{_{—}}_{SWD} [symbol] |δ_{SW}|>δ_{SWD} [symbol] |\dot{δ}_{SW}|>\dot{δ}_{SWD} [symbol] |\dot{Ψ}ₑᵣᵣₒᵣ|>\dot{Ψ}ₑᵣᵣₒᵣ_{_{—}}_{SWD} [symbol] |\ddot{Ψ}|>\ddot{Ψ}_{SWD} (6)

|\dot{Ψ}ₑᵣᵣₒᵣ/a_{y}²|>th_{SDW}_{_{—}}ₛ [symbol] |δ_{SW}|>δ_{SWD} [symbol] (\dot{δ}_{SWD}_{_{—}}ₛ₁<|\dot{δ}_{SW}|<\dot{δ}_{SWD}_{_{—}}ₛ₂) [symbol] (\dot{Ψ}ₑᵣᵣₒᵣ_{_{—}}_{SWD}_{_{—}}ₛ₁<|\dot{Ψ}ₑᵣᵣₒᵣ|<\dot{Ψ}ₑᵣᵣₒᵣ_{_{—}}_{SWD}_{_{—}}ₛ₂) [symbol] |\ddot{Ψ}|<\ddot{Ψ}_{SWD}_{_{—}}ₛ (7)

Condition (2) specifies the situation when the driving situation is overtaking an obstacle and the road surface condition is asphalt. Thereby, th_{DLC} denotes a threshold value for the absolute value of the yaw rate error, which is normalized with the lateral acceleration, δ_{DLC} denotes a steering wheel angular displacement lower limit, \dot{δ}_{DLC} denotes a steering wheel angular velocity lower limit, \dot{Ψ}ₑᵣᵣₒᵣ_{_{—}}_{DLC} denotes a yaw rate error lower limit and \ddot{Ψ}_{DLC} denotes a yaw acceleration upper limit. Condition (2) specifies the situation when the driving situation is overtaking an obstacle and the road surface condition is snow. Thereby, δ_{DLC}_{_{—}}ₛ denotes a steering wheel angular displacement lower limit, \dot{δ}_{DLC}_{_{—}}ₛ₁ denotes a steering wheel angular velocity lower limit, \dot{δ}_{DLC}_{_{—}}ₛ₂ denotes a steering wheel angular velocity upper limit, \dot{Ψ}ₑᵣᵣₒᵣ_{_{—}}_{DLC}_{_{—}}ₛ denotes a yaw rate error lower limit, \ddot{Ψ}_{DLC}_{_{—}}ₛ₁ denotes a yaw acceleration lower limit and \ddot{Ψ}_{DLC}_{_{—}}ₛ₂ denotes a yaw acceleration upper limit.

Condition (3) specifies the situation when the driving situation is ramp steering and the road surface condition is asphalt. Thereby, thᵣₐₘₚ₁ denotes a threshold value for the absolute value of the yaw rate error, which is again normalized with the lateral acceleration, δ_{RAMP1} denotes a steering wheel angular displacement lower limit, δ_{RAMP2} denotes a steering wheel angular displacement upper limit, δ_{RAMP} denotes a steering wheel angular velocity upper limit, \dot{Ψ}ₑᵣᵣₒᵣ_{_{—}}_{RAMP} denotes a yaw rate error lower limit and \ddot{Ψ}_{RAMP} denotes a yaw acceleration upper limit.

Condition (4) specifies the situation when the driving situation is ramp steering and the road surface condition is snow. Thereby, thᵣₐₘₚ₂ denotes a threshold value for the absolute value of the yaw rate error, which is normalized with the lateral acceleration raised to the second power. Herein, the yaw rate error is normalized with the lateral acceleration raised to the second power to avoid false warnings that may otherwise occur.

Condition (5) specifies the situation when the driving situation is a curving manoeuvre and the road surface condition is asphalt. Thereby, th_{SDW} denotes a threshold value for the absolute value of the yaw rate error, which is normalized with the yaw rate reference value, a_{y}_{_{—}}_{SWD} denotes a lateral acceleration lower limit, δ_{SWD} denotes a steering wheel angular displacement lower limit, \dot{δ}_{SWD} denotes a steering wheel angular velocity lower limit, \dot{Ψ}ₑᵣᵣₒᵣ_{_{—}}_{SWD} denotes a yaw rate error lower limit and \ddot{Ψ}_{SWD} denotes a yaw acceleration upper limit. Herein, the yaw rate error is normalized with the calculated yaw rate reference value instead of the lateral acceleration. The reason for this is to avoid false warnings that may otherwise occur due to the problematic associated with different friction surfaces.

Condition (6) specifies the situation when the driving situation is a curving manoeuvre and the road surface condition is snow. Thereby, th_{SWD}_{_{—}}ₛ denotes a threshold value for the absolute value of the yaw rate error, which is normalized with the lateral acceleration raised to the second power, \dot{δ}_{SWD}_{_{—}}ₛ₁ denotes a steering wheel angular velocity lower limit, \dot{δ}_{SWD}_{_{—}}ₛ₂ denotes a steering wheel angular velocity upper limit, \dot{Ψ}ₑᵣᵣₒᵣ_{_{—}}_{SWD}_{_{—}}ₛ₁ denotes a yaw rate error lower limit, \dot{Ψ}ₑᵣᵣₒᵣ_{_{—}}_{SWD}_{_{—}}ₛ₂ denotes a yaw rate error upper limit and \ddot{Ψ}_{SWD}_{_{—}}ₛ denotes a yaw acceleration lower limit.

The thresholds for the absolute value of the yaw rate error \dot{Ψ}ₑᵣᵣₒᵣ and on the steering wheel angular displacement δ_{SW} in inequalities serve to differentiate the type of manoeuvre and to prevent false warnings. The thresholds for the yaw acceleration \ddot{Ψ} and the steering wheel angular velocity \dot{δ}_{SW} in the inequalities are to determine, how dynamic the manoeuvre is. In a further inequality of conditions (2), (3), (4), and (6), the absolute value of the yaw rate error \dot{Ψ}ₑᵣᵣₒᵣ is normalized with the absolute value of the lateral acceleration a_{y} and compared with a given threshold th_{DLC}, to make the system more sensitive to yaw rate deviations, that typically occur for low lateral accelerations on low friction surfaces. In condition (5), the yaw rate error is normalized with the absolute value of the yaw rate reference value instead of the lateral acceleration, to avoid false warnings that would else occur due to the problematic with different friction surfaces.

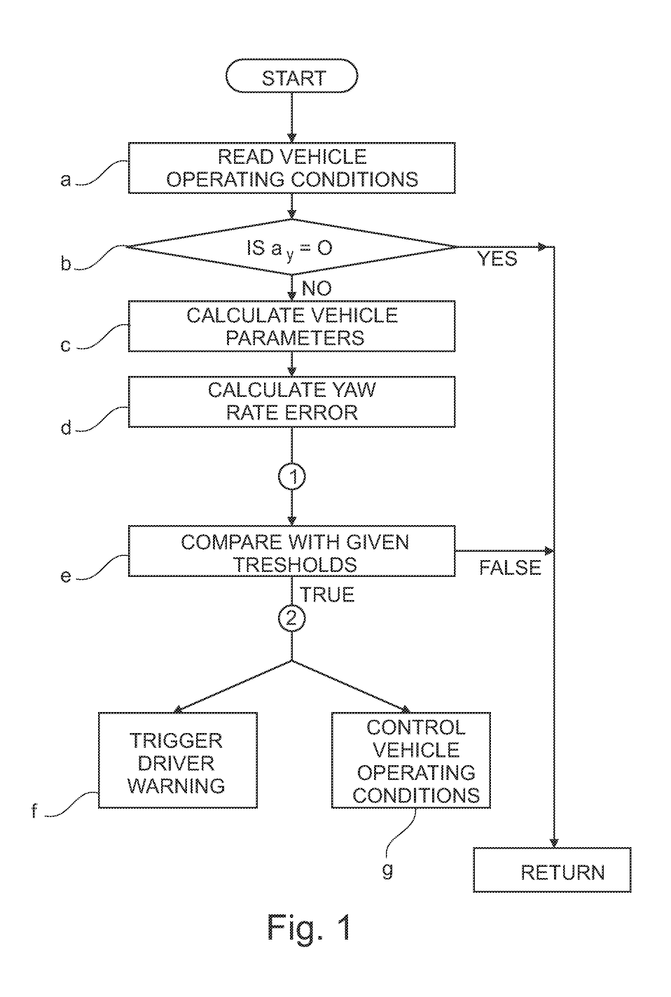

Finally, referring again to FIG. 1, at a step f and/or at a step g, when each set criteria of a condition of said set of inequalities is fulfilled, this is an indication that the cornering limit will be reached. Then, a driver warning is triggered to warn the driver some time prior to the vehicle reaching the cornering limit, or the vehicle operating conditions are controlled. If one or more of the actual vehicle dynamics are not in a predetermined range of their given threshold, the method returns to step a.

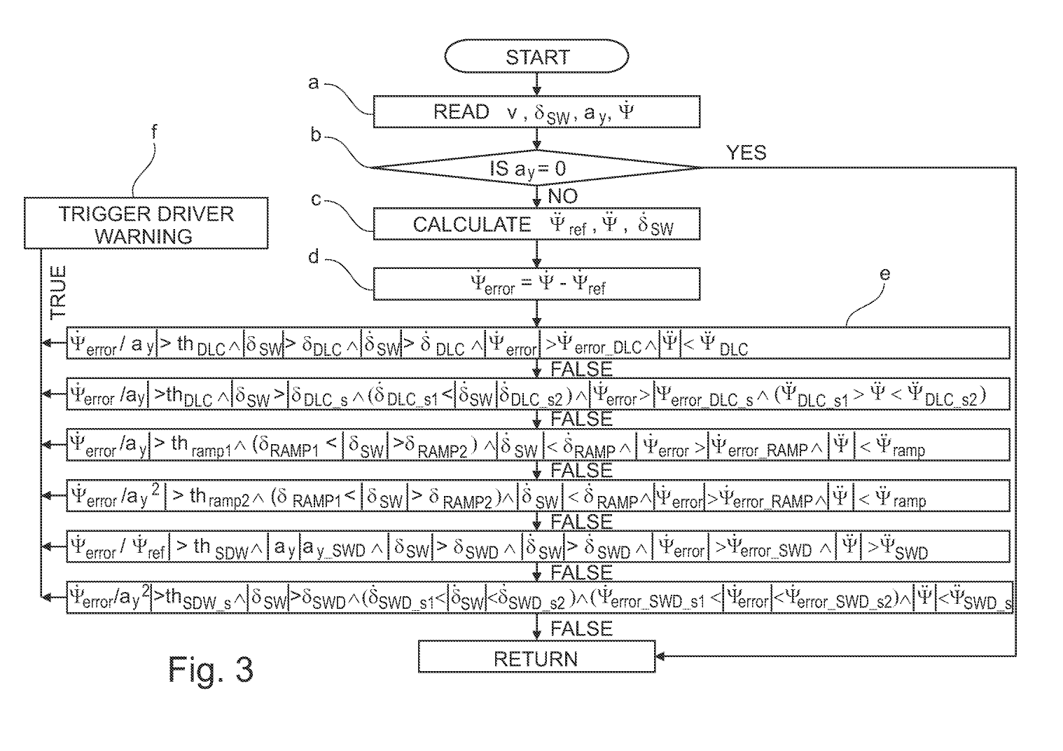

FIG. 3 illustrates an embodiment with which each of the steps of the method for estimating a cornering limit may be performed. In this example the, at step (a), sensed vehicle operating conditions are a vehicular velocity v, a lateral acceleration of the vehicle a_{y}, a steering wheel angular displacement of a vehicular steering wheel δ_{SW} and a vehicular yaw rate \dot{Ψ}.

In this embodiment of the invention the, at step (c), calculated vehicle parameters are a steering wheel angular velocity \dot{δ}_{SW}, a yaw acceleration \ddot{Ψ} and a yaw rate reference value \ddot{Ψ}_{ref}. The vehicle parameters can be calculated by use of common software packages simulating the dynamical behaviour of a vehicle. The yaw rate reference value \dot{Ψ}_{ref} can be also obtained by using a linear bicycle model or a full car model for a four wheeled vehicle.

As illustrated again in the embodiment of FIG. 3, there are several measured or calculated dynamical vehicle parameters used, to determine when the cornering limit will be reached. The steps (b), (d), (e) and (f) of the method are performed similar as shown in FIG. 1 and FIG. 2.

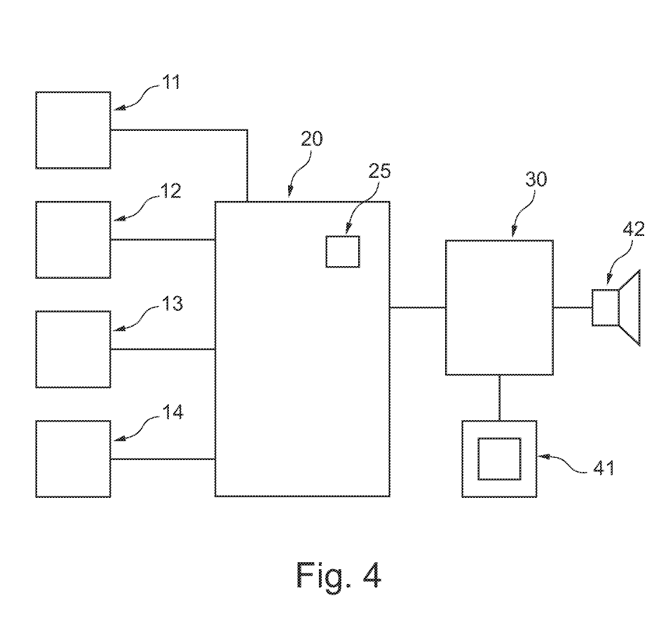

FIG. 4 shows a block diagram illustrating an estimation system 1, according to one embodiment. This estimation system 1 may be used to carry out the method of one of the embodiments of the present application. At first vehicle operating conditions are detected by a sensor group 11, 12, 13, 14. In particular, there is a lateral acceleration sensor 11 to detect a lateral acceleration of the vehicle a_{y}, a vehicular velocity sensor 12 to detect a vehicular velocity v, a steering wheel angular displacement sensor 13 to detect an angular displacement of a vehicular steering wheel δ_{SW} and a yaw rate sensing means 14 to detect a vehicular yaw rate \dot{Ψ}.

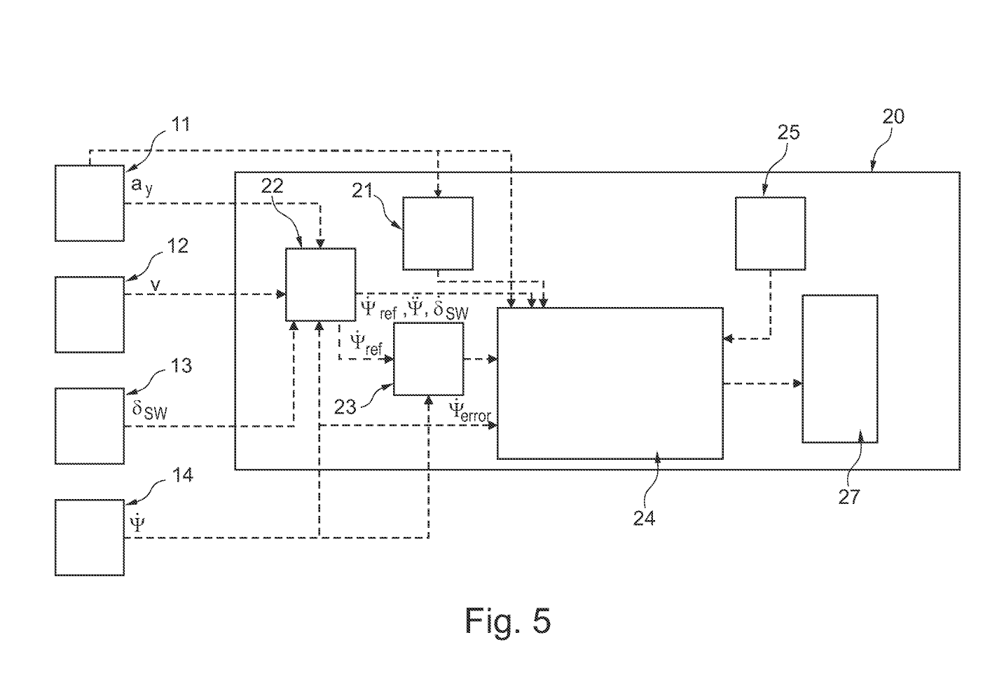

Detection signals of these sensors 11, 12, 13, 14 are inputted into an electric control unit 20, which is described in detail below with reference to FIG. 5. If the electronic control unit 20 outputs, that a driver warning is triggered, a command to output a warning is transferred to a converter 30. By use of said converter, a driver warning 41, 42 can be activated. Therein, any known driver warning 41, 42 can be used, such as an optical driver warning 41 or an acoustical driver warning 42. It should be noted that an optical driver warning 41 should be arranged clearly visible for the driver and that a voice production unit is necessary to convert the electronic signal into an acoustic signal, if an acoustical driver warning 42 is used.

FIG. 5 shows a schematic functional block diagram characteristics graph of the electronic control unit 20, according to the embodiment of FIG. 4. The electronic control unit comprises a vehicle condition detector 21, a vehicle parameter calculating section 22, a yaw rate error calculating means 23, estimating section 24 and alarm unit 26.

In the electronic control unit 20, shown in FIG. 4, a vehicle condition detector 21 determines whether the lateral acceleration a_{y} is equal to zero in accordance with the detected value of the lateral acceleration sensor 11. The vehicular parameter calculating section 22 receives sensor outputs from the lateral acceleration sensor 11, the vehicular velocity sensor 12, the steering wheel angular displacement sensor 13 and the yaw rate sensing means 14, to calculate a yaw rate reference value \dot{Ψ}_{ref}, a yaw acceleration \ddot{Ψ} and a steering wheel angular velocity \dot{δ}_{SW}.

The yaw rate error calculating means 23 calculates a yaw rate error \dot{Ψ}ₑᵣᵣₒᵣ from the signal of the yaw rate sensing means 14 and the calculated yaw rate reference value \dot{Ψ}_{ref}. The estimating section 24 estimates, whether the vehicle dynamics are within a predetermined range of given thresholds on the basis of the outputs from the lateral acceleration sensor 11, the steering wheel angular displacement sensor 13, the yaw rate sensing means 14, the vehicle condition detector 21, the vehicle parameter calculating section 22 and the yaw rate error calculating means 23. In the electronic control unit 20, the predefined thresholds are stored in a ROM memory store 25.

If the estimating section 24 estimates that the vehicle operating conditions and the vehicle parameters are within a predetermined range of the given thresholds, the estimating section switches and generates a signal to an alarm unit 26. The alarm unit 26 further sends a command to the converter 30 to activate a driver warning 41, 42, as described above.

While at least one exemplary embodiment has been presented in the foregoing summary and detailed description, it should be appreciated that a vast number of variations exist. It should also be appreciated that the exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the functions and arrangement of elements described in an exemplary embodiment without departing from the scope as set forth in the appended claims and their legal equivalents.

What is claimed is:

1. A method for estimating a cornering limit of an automotive vehicle, comprising:
sensing vehicle operating conditions and a vehicular yaw rate;
detecting a lateral acceleration of the vehicle and determining whether the lateral acceleration is equal to zero;
calculating vehicle parameters and a yaw rate reference value;
calculating a yaw rate error on a basis of the yaw rate reference value and a previously sensed vehicular yaw rate;
estimating whether the vehicle operating conditions, the vehicle parameters and the yaw rate error are within a predetermined range of given thresholds, responsive to a driving situation of a condition if the lateral acceleration is determined as being unequal to zero;
triggering a driver warning if the vehicle operating conditions, the vehicle parameters and the yaw rate error are within a predetermined range of the thresholds; and
controlling the vehicle operating conditions so that the vehicle operating conditions, the vehicle parameters and the yaw rate error are within the predetermined range of the thresholds.

2. The method according to claim 1, wherein the sensing vehicle operating conditions and the vehicular yaw rate comprises:
sensing a vehicular velocity;
sensing a steering wheel angular displacement of a vehicular steering wheel,
sensing a vehicular yaw rate.

3. The method according to claim 2, wherein the calculating vehicle parameters and the yaw rate reference value comprises:
calculating a yaw rate reference value; and
calculating vehicular yaw acceleration, and calculating a steering wheel angular velocity of the vehicular steering wheel.

4. The method according to claim 1, wherein the calculating the yaw rate error \dot{Ψ}ₑᵣᵣₒᵣ is calculated as follows:
\dot{Ψ}ₑᵣᵣₒᵣ=\dot{Ψ}\dot{−}\dot{Ψ}_{ref}
wherein \dot{Ψ} denotes a measured yaw rate and \dot{Ψ}_{ref} denotes are calculated yaw rate reference value.

5. The method according to claim 4, wherein the estimating is conducted with a system of inequalities.

6. The method according to claim 4, wherein the system of inequalities comprises a road surface condition and the driving situation and wherein each condition comprises a set criteria for the vehicle operating conditions, the vehicle parameters and the yaw rate error.

7. The method according to claim 6, wherein the driving situation can be overtaking an obstacle.

8. The method according to claim 7, wherein each condition comprises a set of criteria for the yaw rate error, the lateral acceleration, the steering wheel angular displacement, the steering wheel angular velocity, and the vehicular yaw acceleration.

9. The method according to claim 7, wherein the estimating determines whether all set criteria of one condition is fulfilled.

10. The method according to claim 9, wherein, when the system of inequalities comprises the one condition and the estimating determines if the set criteria of the condition are fulfilled, and further comprising:
continuing if all set criteria are fulfilled; and
returning to sensing the vehicle operating conditions and the vehicular yaw rat if all set criteria are not fulfilled.

11. The method according to claim 9,
wherein, when the system of inequalities comprises at least conditions and the estimating determines if all set criteria of the system of inequalities are fulfilled for a first condition of the at least two conditions after another condition, beginning with the first condition,
wherein the method further comprises continuing if the set criteria of the first condition are fulfilled; and
determining the set criteria of a next condition if the set criteria of the first condition are not fulfilled; and
returning to the sensing vehicle operating conditions and the vehicular yaw rate if all set criteria of none of the two or more conditions of the system of inequalities are fulfilled.

12. The method according to claim 11, wherein the system of inequalities comprises two or more of an inequality group consisting of:

|\dot{Ψ}ₑᵣᵣₒᵣ/a_{y}|>th_{DLC} [symbol] |δ_{SW}|>δhd DLC [symbol] |\dot{δ}_{SW}′>\dot{δ}_{DLC} [symbol] |\dot{Ψ}ₑᵣᵣₒᵣ|>\dot{Ψ}ₑᵣᵣₒᵣ_{_{—}}_{DLC} [symbol] |\ddot{Ψ}|<\ddot{Ψ}_{DLC}

|\dot{Ψ}ₑᵣᵣₒᵣ/a_{y}|>th_{DLC} [symbol] |δ_{SW}|>δ_{DLC}_{_{—}}ₛ [symbol] (\dot{δ}_{DLC}_{_{—}}ₛ₁<|\dot{δ}_{SW}|<\dot{δ}_{DLC}_{_{—}}ₛ₂) [symbol] |\dot{Ψ}ₑᵣᵣₒᵣ|>\dot{Ψ}ₑᵣᵣₒᵣ_{_{—}}_{DLC}_{_{—}}ₛ [symbol] (\ddot{Ψ}_{DLC}_{_{—}}ₛ₁<|\ddot{Ψ}|<\ddot{Ψ}_{DLC}_{_{—}}ₛ₂)

|\dot{Ψ}ₑᵣᵣₒᵣ/a_{y}|>thᵣₐₘₚ₁ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP}

|\dot{Ψ}ₑᵣᵣₒᵣ/a_{y}²|>thᵣₐₘₚ₂ [symbol] (δ_{RAMP1}<|δ_{SW}|<δ_{RAMP2}) [symbol] |\dot{δ}_{SW}|<\dot{δ}_{RAMP} [symbol] \dot{Ψ}ₑᵣᵣₒᵣ|>\dot{Ψ}ₑᵣᵣₒᵣ_{_{—}}_{RAMP} [symbol] |\ddot{Ψ}|<\ddot{Ψ}_{RAMP}

|\dot{Ψ}ₑᵣᵣₒᵣ/\dot{Ψ}_{ref}|>th_{SDW} [symbol] a_{y}|>a_{y}_{_{—}}_{SWD} [symbol] |δ_{SW}|>δ_{SWD} [symbol] |\dot{δ}_{SW}|>\dot{δ}_{SWD} [symbol] |\dot{Ψ}ₑᵣᵣₒᵣ|>\dot{Ψ}ₑᵣᵣₒᵣ_{_{—}}_{SWD} [symbol] |\ddot{Ψ}|>\ddot{Ψ}_{SWD}

|\dot{Ψ}ₑᵣᵣₒᵣ/a_{y}²|>th_{SDW}_{_{—}}ₛ [symbol] |δ_{SW}|>δ_{SWD} [symbol] (\dot{δ}_{SWD}_{_{—}}ₛ₁<|\dot{δ}_{SW}|<\dot{δ}_{SWD}_{_{—}}ₛ₂) [symbol] (\dot{Ψ}ₑᵣᵣₒᵣ_{_{—}}_{SWD}_{_{—}}ₛ₁<|\dot{Ψ}ₑᵣᵣₒᵣ|<\dot{Ψ}ₑᵣᵣₒᵣ_{_{—}}_{SWD}_{_{—}}ₛ₂) [symbol] |\ddot{Ψ}|<\ddot{Ψ}_{SWD}_{_{—}}ₛ,
wherein \dot{Ψ}ₑᵣᵣₒᵣ denotes the yaw rate error, \dot{Ψ}_{ref} denotes the yaw rate reference value, a_{y} denotes the lateral acceleration, δ_{SW} denotes the steering wheel angular displacement, \dot{δ}_{SW} denotes the steering wheel angular velocity, \ddot{Ψ} denotes the vehicular yaw acceleration,
wherein if the driving situation is overtaking the obstacle and the road surface condition is asphalt, th_{DLC} denotes a threshold value for an absolute value of the yaw rate error, which is normalized with the lateral acceleration, δ_{DLC} denotes a steering wheel angular displacement lower limit, \dot{δ}_{DLC} denotes a steering wheel angular velocity lower limit, \dot{Ψ}ₑᵣᵣₒᵣ DLC denotes a yaw rate error lower limit and \ddot{Ψ}_{DLC} denotes a yaw acceleration upper limit,
if the driving situation is overtaking the obstacle and the road surface condition is snow, th_{DLC} denotes the threshold value for the absolute value of the yaw rate error, which is normalized with the lateral acceleration, δ_{DLC-s} denotes a steering wheel angular displacement lower limit, \dot{δ}_{DLC-s1} denotes a steering wheel angular velocity lower limit, \dot{δ}_{DLC-s1} denotes a steering wheel angular velocity upper limit, \dot{Ψ}ₑᵣᵣₒᵣ_{_{—}}_{DLC-s} denotes a yaw rate error lower limit, \ddot{Ψ}_{DLC-s1} denotes a yaw acceleration lower limit and \ddot{Ψ}_{DLC-s2} denotes a yaw acceleration upper limit,
if the driving situation is ramp steering and the road surface condition is asphalt, th_{RAMP1} denotes the threshold value for the absolute value of the yaw rate error, which is normalized with the lateral acceleration, δ_{RAMP1} denotes a steering wheel angular displacement lower limit, δ_{RAMP2} denotes a steering wheel angular displacement upper limit, \dot{δ}_{RAMP} denotes a steering wheel angular velocity upper limit, \dot{Ψ}ₑᵣᵣₒᵣ_{_{—}}_{RAMP} denotes a yaw rate error lower limit and \ddot{Ψ}_{RAMP} denotes a yaw acceleration upper limit,
if the driving situation is ramp steering and the road surface condition is snow, th_{RAMP2} denotes the threshold value for the absolute value of the yaw rate error, which is normalized with the lateral acceleration raised to the second power, δ_{RAMP1} denotes a steering wheel angular displacement lower limit, δ_{RAMP2} denotes a steering wheel angular displacement upper limit, \dot{δ}_{RAMP} denotes a steering wheel angular velocity upper limit, \dot{Ψ}ₑᵣᵣₒᵣ_{_{—}}_{RAMP} denotes a yaw rate error lower limit and \ddot{Ψ}_{RAMP} denotes a yaw acceleration upper limit,
if the driving situation is a curving manoeuvre and the road surface condition is asphalt, th_{SDW} denotes the threshold value for the absolute value of the yaw rate error, which is normalized with the yaw rate reference value, a_{y-SWD} denotes a lateral acceleration lower limit, δ_{SWD} denotes a steering wheel angular displacement lower limit, δ_{SWD} denotes a steering wheel angular velocity lower limit, \dot{Ψ}ₑᵣᵣₒᵣ_{_{—}}_{SWD} denotes a yaw rate error lower limit and \ddot{Ψ}_{SWD} denotes a yaw acceleration upper limit,
if the driving situation is the curving manoeuvre and the road surface condition is snow, th_{SWD-s} denotes the threshold value for the absolute value of the yaw rate error, which is normalized with the lateral acceleration raised to the second power, δ_{SWD} denotes a steering wheel angular displacement lower limit, \dot{δ}_{SWD-s1} denotes a steering wheel angular velocity lower limit, \dot{δ}_{SWD-s2} denotes a steering wheel angular velocity upper limit, \dot{Ψ}ₑᵣᵣₒᵣ_{_{—}}_{SWD-s1} denotes a yaw rate error lower limit, \dot{Ψ}ₑᵣᵣₒᵣ_{_{—}}_{SWD-s2} denotes a yaw rate error upper limit and \ddot{Ψ}_{SWD}_{_{—}}ₛ denotes a yaw acceleration lower limit.

13. The method according to claim 5, wherein warning triggers the driver warning, when all the set criteria of one condition of the system of inequalities are fulfilled; and
controlling the vehicle operating conditions when all the set criteria of the one condition of the system of inequalities are fulfilled.

14. A system for estimating a cornering limit of an automotive vehicle, the system comprising:
a vehicular velocity sensor adapted to detect a vehicular velocity;
a steering wheel angular displacement sensor adapted to detect a steering angular displacement of a vehicular steering wheel;
a yaw rate sensor adapted to detect a vehicular yaw rate;
a lateral acceleration sensor adapted to detect a lateral acceleration of the vehicle; and
an electronic control unit configured to:
receive the vehicular velocity;
receive the steering angular displacement of a vehicular steering wheel;
receive the vehicular yaw rate;
receive the lateral acceleration of the vehicle;
determine whether the lateral acceleration is equal to zero;
calculate a yaw rate reference value, a yaw acceleration and a steering wheel angular velocity of the vehicular steering wheel;
calculate a yaw rate error;
estimate if the vehicle operating conditions and the vehicle parameters are within a predetermined range of given thresholds; and
initiate an alarm signal if the vehicle operating conditions and the vehicle parameters are within a predetermined range of the thresholds; and
a driver warning responsive to the alarm signal.

15. The system according to claim 14, wherein the yaw rate error \dot{Ψ}ₑᵣᵣₒᵣ is calculated as follows:
\dot{Ψ}ₑᵣᵣₒᵣ=\dot{Ψ}\dot{−}\dot{Ψ}_{ref}
wherein \dot{Ψ} denotes a measured yaw rate and \dot{Ψ}_{ref} denotes a calculated yaw rate reference value.

16. The system according to claim 14, wherein the electronic control unit is adapted to estimate with a system of inequalities.

17. The system according to claim 16, wherein the system of inequalities comprises a condition specifying a road surface condition and a driving situation and wherein each condition comprises a set criteria for the vehicle operating conditions, the vehicle parameters and the yaw rate error.

18. A computer readable medium embodying a computer program product, said computer program product comprising:
a program for estimating a cornering limit of an automotive vehicle, the program configured to:
sense vehicle operating conditions and a vehicular yaw rate;
detect a lateral acceleration of the vehicle and determining whether the lateral acceleration is equal to zero;
calculate vehicle parameters and a yaw rate reference value;
calculate a yaw rate error on a basis of the yaw rate reference value and a previously sensed vehicular yaw rate;
estimate whether the vehicle operating conditions, the vehicle parameters and the yaw rate error are within a predetermined range of given thresholds, responsive to a driving situation of a condition if the lateral acceleration is determined as being unequal to zero;
trigger a driver warning if the vehicle operating conditions, the vehicle parameters and the yaw rate error are within a predetermined range of the thresholds; and
control the vehicle operating conditions so that the vehicle operating conditions, the vehicle parameters and the yaw rate error are within the predetermined range of the thresholds.

19. The computer readable medium according to claim 18, wherein the program is further adapted to:
sense a vehicular velocity;
sense a steering wheel angular displacement of a vehicular steering wheel; and
sense a vehicular yaw rate.

20. The computer readable medium according to claim 18, wherein the program is further adapted to:
calculate a yaw rate reference value; and
calculate a vehicular yaw acceleration, and calculating a steering wheel angular velocity of the vehicular steering wheel.
